(19) United States
(12) Patent Application Publication
(10) Pub. No.: US 2021/0081677 A1
(43) Pub. Date: Mar. 18, 2021

(54) Unsupervised Video Object Segmentation and Image Object Co-Segmentation Using Attentive Graph Neural Network Architectures

(71) Applicant: Inception Institute of Artificial Intelligence, Ltd., Abu Dhabi (AE)

(72) Inventors: Wenguan Wang, Abu Dhabi (AE); Jianbing Shen, Abu Dhabi (AE); Xiankai Lu, Abu Dhabi (AE); Ling Shao, Abu Dhabi (AE)

(21) Appl. No.: 16/574,864

(22) Filed: Sep. 18, 2019

(51) Int. Cl. G06K 9/00; G06T 7/174; G06N 3/08; G06F 16/901

(52) U.S. Cl. CPC G06K 9/00765; G06F 16/9024; G06N 3/088; G06T 7/174

(57) ABSTRACT

This disclosure relates to improved techniques for performing image segmentation functions using neural network architectures. The neural network architecture can include an attentive graph neural network (AGNN) that facilitates performance of unsupervised video object segmentation (UVOS) functions and image object co-segmentation (IOCS) functions. The AGNN can generate a graph that utilizes nodes to represent images (e.g., video frames) and edges to represent relations between the images. A message passing function can propagate messages among the nodes to capture high-order relationship information among the images, thus providing a more global view of the video or image content. The high-order relationship information can be utilized to more accurately perform UVOS and/or IOCS functions.

### TECHNICAL FIELD

This disclosure is related to improved techniques for performing computer vision functions and, more particularly, to techniques that utilize trained neural networks and artificial intelligence (AI) algorithms to perform video object segmentation and object co-segmentation functions.

### BACKGROUND

In the field of computer vision, video object segmentation functions are utilized to identify and segment target objects in video sequences. For example, in some cases, video object segmentation functions may aim to segment out primary or significant objects from foreground regions of video sequences. Unsupervised video object segmentation (UVOS) functions are particularly attractive for many video processing and computer vision applications because they do not require extensive manual annotations or labeling on the images or videos during inference.

Image object co-segmentation (IOCS) functions are another class of computer vision tasks. Generally speaking, IOCS functions aim to jointly segment common objects belonging to the same semantic class in a given set of related images. For example, given a collection of images, IOCS functions may analyze the images to identify semantically similar objects that are associated with certain object categories (e.g., human category, tree category, house category, etc.).

Configuring neural networks to perform UVOS and IOCS functions is a complex and challenging task. A variety of technical problems must be overcome to accurately implement these functions. One technical problem relates to overcoming challenges associated with training neural networks to accurately discover target objects across video frames or images. This is particularly difficult for unsupervised functions that do not have prior knowledge of target objects. Another technical problem relates to accurately identifying target objects that experience heavy occlusions, large scale variations, and appearance changes across different frames or images of the video sequences. Traditional techniques often fail to adequately address these and other technical problems because they are unable to obtain or utilize high-order and global relationship information among the images or video frames being analyzed.

### BRIEF DESCRIPTION OF DRAWINGS

The patent or application file contains at least one drawing executed in color. Copies of this patent or patent application publication with color drawing(s) will be provided by the Office, upon request and payment of the necessary fee.

To facilitate further description of the embodiments, the following drawings are provided, in which like references are intended to refer to like or corresponding parts, and in which:

FIG. 1 is a diagram of an exemplary system in accordance with certain embodiments;

FIG. 2 is a block diagram of an exemplary computer vision system in accordance with certain embodiments;

FIG. 3 is a diagram illustrating an exemplary process flow for performing UVOS in accordance with certain embodiments;

FIG. 4 is a diagram illustrating an exemplary architecture for a computer vision system in accordance with certain embodiments;

FIG. 5A is a diagram illustrating an exemplary architecture for extracting or obtaining node embeddings in accordance with certain embodiments;

FIG. 5B is a diagram illustrating an exemplary architecture for an intra-node attention function in accordance with certain embodiments;

FIG. 5C is a diagram illustrating an exemplary architecture for an inter-node attention function in accordance with certain embodiments;

FIG. 6 illustrates exemplary UVOS segmentation results that were generated according to certain embodiments;

FIG. 7 illustrates exemplary IOCS segmentation results that were generated according to certain embodiments; and

FIG. 8 is a flow chart of an exemplary method according to certain embodiments.

### DETAILED DESCRIPTION OF EXEMPLARY EMBODIMENTS

The present disclosure relates to systems, methods, and apparatuses that utilize improved techniques for performing computer vision functions, including unsupervised video object segmentation (UVOS) functions and image object co-segmentation (IOCS) functions. A computer vision system includes a neural network architecture that can be trained to perform the UVOS and IOCS functions. The computer vision system can be configured to execute the UVOS functions on images (e.g., frames) associated with videos to identify and segment target objects (e.g., primary or prominent objects in the foreground portions) captured in the frames or images. The computer vision system additionally, or alternatively, can be configured to execute the IOCS functions on images to identify and segment semantically similar objects belonging to one or more semantic classes. The computer vision system may be configured to perform other related functions as well.

In certain embodiments, the neural network architecture utilizes an attentive graph neural network (AGNN) to facilitate performance of the UVOS and IOCS functions. In certain embodiments, the AGNN executes a message passing function that propagates messages among its nodes to enable the AGNN to capture high-order relationship information among video frames or images, thus providing a more global view of the video or image content. The AGNN is also equipped to preserve spatial information associated with the video or image content. The spatial preserving properties and high-order relationship information captured by the AGNN enable it to more accurately perform segmentation functions on video and image content.

In certain embodiments, the AGNN can generate a graph that comprises a plurality of nodes and a plurality of edges, each of which connects a pair of nodes to each other. The nodes of the AGNN can be used to represent the images or frames received, and the edges of the AGNN can be used to represent relations between node pairs included in the AGNN. In certain embodiments, the AGNN may utilize a fully-connected graph in which each node is connected to every other node by an edge.

Each image included in a video sequence or image dataset can be processed with a feature extraction component (e.g., a convolutional neural network, such as DeepLabV3, that is configured for semantic segmentation) to generate a corresponding node embedding (or node representation). Each node embedding comprises image features corresponding to an image in the video sequence or image dataset, and each node embedding can be associated with a separate node of the AGNN. For each pair of nodes included in the graph, an attention component can be utilized to generate a corresponding edge embedding (or edge representation) that captures relationship information between the nodes, and the edge embedding can be associated with an edge in the graph that connects the node pair. Use of the attention component to capture this correlation information can be beneficial because it avoids the time-consuming optical flow estimation functions typically associated with other UVOS and IOCS techniques.

After the initial node embeddings and edge embeddings are associated with the graph, a message passing function can be executed to update the node embeddings by iteratively propagating information over the graph such that each node receives the relationship information or node embeddings associated with connected nodes. The message passing function permits rich and high-order relations to be mined among the images, thus enabling a more complete understanding of image content and more accurate identification of target objects within a video or image dataset. The high-order relationship information may be utilized to identify and segment target objects (e.g., foreground objects) for performing UVOS functions and/or may be utilized to identify common objects in semantically-related images for performing IOCS functions. A readout function can map the node embeddings that are updated with the high-order relationship information to outputs or produce final segmentation results.

The segmentation results generated by the AGNN may include, inter alia, masks that identify the target objects. For example, in executing a UVOS function on video sequence, the segmentation results may comprise segmentation masks that identify primary or prominent objects in the foreground portions of scenes captured in the frames or images of a video sequence. Similarly, in executing an IOCS function, the segmentation results may comprise segmentation masks that identify semantically similar objects in a collection of images (e.g., which may or may not include images from a video sequence). The segmentation results also can include other information associated with the segmentation functions performed by the AGNN.

The technologies described herein can be used in a variety of different contexts and environments. Generally speaking, the technologies disclosed herein may be integrated into any application, device, apparatus, and/or system that can benefit from UVOS and/or IOCS functions. In certain embodiments, the technologies can be incorporated directly into image capturing devices (e.g., video cameras, smart phones, cameras, etc.) to enable these devices to identify and segment target objects captured in videos or images. These technologies additionally, or alternatively, can be incorporated into systems or applications that perform post-processing operations on videos and/or images captured by image capturing devices (e.g., video and/or image editing applications that permit a user to alter or edit videos and images). These technologies can be integrated with, or otherwise applied to, videos and/or images that are made available by various systems (e.g., surveillance systems, facial recognition systems, automated vehicular systems, social media platforms, etc.). The technologies discussed herein can also be applied to many other contexts as well.

Furthermore, the image segmentation technologies described herein can be combined with other types of computer vision functions to supplement the functionality of the computer vision system. For example, in addition to performing image segmentation functions, the computer vision system can be configured to execute computer vision functions that classify objects or images, perform object counting, perform re-identification functions, etc. The accuracy and precision of the automated segmentation technologies described herein can aid in performing these and other computer vision functions.

As evidenced by the disclosure herein, the inventive techniques set forth in this disclosure are rooted in computer technologies that overcome existing problems in known computer vision systems, specifically problems dealing with performing unsupervised video object segmentation functions and image object co-segmentation. The techniques described in this disclosure provide a technical solution (e.g., one that utilizes various AI-based neural networking and machine learning techniques) for overcoming the limitations associated with known techniques. For example, the image analysis techniques described herein take advantage of novel AI and machine learning techniques to learn functions that may be utilized to identify and extract target objects in videos and/or image datasets. This technology-based solution marks an improvement over existing capabilities and functionalities related to computer vision systems by improving the accuracy of the unsupervised video object segmentation functions and image object co-segmentation, and reducing the computational costs associated with performing such functions.

The embodiments described in this disclosure can be combined in various ways. Any aspect or feature that is described for one embodiment can be incorporated into any other embodiment mentioned in this disclosure. Moreover, any of the embodiments described herein may be hardware-based, may be software-based, or may comprise a mixture of both hardware and software elements. Thus, while the description herein may describe certain embodiments, features, or components as being implemented in software or hardware, it should be recognized that any embodiment, feature, or component that is described in the present application may be implemented in hardware and/or software.

Embodiments may include a computer program product accessible from a computer-usable or computer-readable medium providing program code for use by or in connection with a computer or any instruction execution system. A computer-usable or computer-readable medium may include any apparatus that stores, communicates, propagates, or transports the program for use by or in connection with the instruction execution system, apparatus, or device. The medium can be a magnetic, optical, electronic, electromagnetic, infrared, or semiconductor system (or apparatus or device), or may be a propagation medium. The medium may include a computer-readable storage medium, such as a semiconductor, solid state memory, magnetic tape, a removable computer diskette, a random access memory (RAM), a read-only memory (ROM), a programmable read-only memory (PROM), a static random access memory (SRAM), a rigid magnetic disk, and/or an optical disk.

A data processing system suitable for storing and/or executing program code may include at least one processor coupled directly or indirectly to memory elements through a system bus. The at least one processor can include: one or more central processing units (CPUs), one or more graphics processing units (CPUs), one or more controllers, one or more microprocessors, one or more digital signal processors, and/or one or more computational circuits. The memory elements can include local memory employed during actual execution of the program code, bulk storage, and cache memories that provide temporary storage of at least some program code to reduce the number of times code is retrieved from bulk storage during execution. Input/output or I/O devices (including, but not limited to, keyboards, displays, pointing devices, etc.) may be coupled to the system, either directly or through intervening I/O controllers.

Network adapters may also be coupled to the system to enable the data processing system to become coupled to other data processing systems, remote printers, or storage devices through intervening private or public networks. Modems, cable modems, and Ethernet cards are just a few of the currently available types of network adapters.

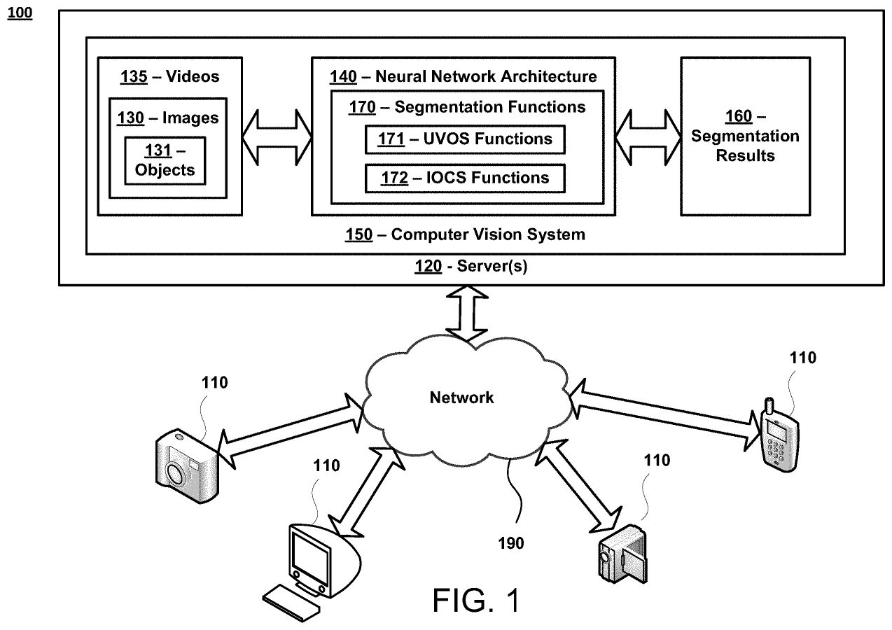

FIG. 1 is a diagram of an exemplary system 100 in accordance with certain embodiments. The system 100 comprises one or more computing devices 110 and one or more servers 120 that are in communication over a network 190. A computer vision system 150 is stored on, and executed by, the one or more servers 120. The network 190 may represent any type of communication network, e.g., such as one that comprises a local area network (e.g., a Wi-Fi network), a personal area network (e.g., a Bluetooth network), a wide area network, an intranet, the Internet, a cellular network, a television network, and/or other types of networks.

All the components illustrated in FIG. 1, including the computing devices 110, servers 120, and computer vision system 150, can be configured to communicate directly with each other and/or over the network 190 via wired or wireless communication links, or a combination of the two. Each of the computing devices 110, servers 120, and computer vision system 150 can also be equipped with one or more transceiver devices, one or more computer storage devices (e.g., RAM, ROM, PROM, SRAM, etc.), and one or more processing devices (e.g., CPUs, GPUs, etc.) that are capable of executing computer program instructions. The computer storage devices can be physical, non-transitory mediums.

In certain embodiments, the computing devices 110 may represent desktop computers, laptop computers, mobile devices (e.g., smart phones, personal digital assistants, tablet devices, vehicular computing devices, or any other device that is mobile in nature), image capturing devices, and/or other types of devices. The one or more servers 120 may generally represent any type of computing device, including any of the computing devices 110 mentioned above. In certain embodiments, the one or more servers 120 comprise one or more mainframe computing devices that execute web servers for communicating with the computing devices 110 and other devices over the network 190 (e.g., over the Internet).

In certain embodiments, the computer vision system 150 is stored on, and executed by, the one or more servers 120. The computer vision system 150 can be configured to perform any and all functions associated with analyzing images 130 and videos 135, and generating segmentation results 160. This may include, but is not limited to, computer vision functions related to performing unsupervised video object segmentation (UVOS) functions 171 (e.g., which may include identifying and segmenting objects 131 in the images or frames of videos 135), image object co-segmentation (IOCS) functions 172 (e.g., which may include identifying and segmenting semantically similar objects 131 identified in a collection of images 130), and/or other related functions. In certain embodiments, the segmentation results 160 output by the computer vision system 150 can identify boundaries of target objects 131 with pixel-level accuracy.

The images 130 provided to, and analyzed by, the computer vision system 150 can include any type of image. In certain embodiments, the images 130 can include one or more two-dimensional (2D) images. In certain embodiments, the images 130 may additionally, or alternatively, include one or more three-dimensional (3D) images. In certain embodiments, the images 130 may correspond to frames of a video 135. The videos 135 and/or images 130 may be captured in any digital or analog format and may be captured using any color space or color model. Exemplary image formats can include, but are not limited to, JPEG (Joint Photographic Experts Group), TIFF (Tagged Image File Format), GIF (Graphics Interchange Format), PNG (Portable Network Graphics), etc. Exemplary video formats can include, but are not limited to, AVI (Audio Video Interleave), QTFF (QuickTime File Format), WMV (Windows Media Video), RM (RealMedia), ASF (Advanced Systems Format), MPEG (Moving Picture Experts Group), etc. Exemplary color spaces or models can include, but are not limited to, sRGB (standard Red-Green-Blue), Adobe RGB, gray-scale, etc. In certain embodiments, pre-processing functions can be applied to the videos 135 and/or images 130 to adapt the videos 135 and/or images 130 to a format that can assist the computer vision system 150 with analyzing the videos 135 and/or images 130.

The videos 135 and/or images 130 received by the computer vision system 150 can be captured by any type of image capturing device. The image capturing devices can include any devices that are equipped with an imaging sensor, camera, and/or optical device. For example, the image capturing device may represent still image cameras, video cameras, and/or other devices that include image/video sensors. The image capturing devices can also include devices that comprise imaging sensors, cameras, and/or optical devices that are capable of performing other functions unrelated to capturing images. For example, the image capturing device can include mobile devices (e.g., smart phones or cell phones), tablet devices, computing devices, desktop computers, etc. The image capturing devices can be equipped with analog-to-digital (ND) converters and/or digital-to-analog (D/A) converters based on the configuration or design of the camera devices. In certain embodiments, the computing devices 110 shown in FIG. 1 can include any of the aforementioned image capturing devices, or other types of image capturing devices.

In certain embodiments, the images 130 processed by the computer vision system 150 can be included in one or more videos 135 and may correspond to frames of the one or more videos 135. For example, in certain embodiments, the computer vision system 150 may receive images 130 associated with one or more videos 135 and may perform UVOS functions 171 on the images 130 to identify and segment target objects 131 (e.g., foreground objects) from the videos 135. In certain embodiments, the images 130 processed by the computer vision system 150 may not be included in a video 135. For example, in certain embodiments, the computer vision system 150 may receive a collection of images 130 and may perform IOCS functions 172 on the images 130 to identify and segment target objects 131 that are included in one or more target semantic classes. In some cases, the IOCS functions 172 can also be performed on images 130 or frames that are included in one or more videos 135.

The images 130 provided to the computer vision system 150 can depict, capture, or otherwise correspond to any type of scene. For example, the images 130 provided to the computer vision system 150 can include images 130 that depict natural scenes, indoor environments, and/or outdoor environments. Each of the images 130 (or the corresponding scenes captured in the images 130) can include one or more objects 131. Generally speaking, any type of object 131 may be included in an image 130, and the types of objects 131 included in an image 130 can vary greatly. The objects 131 included in an image 130 may correspond to various types of living objects (e.g., human beings, animals, plants, etc.), inanimate objects (e.g., beds, desks, windows, tools, appliances, industrial equipment, curtains, sporting equipment, fixtures, vehicles, etc.), structures (e.g., buildings, houses, etc.), and/or the like.

Certain examples discussed below describe embodiments in which the computer vision system 150 is configured to perform UVOS functions 171 to precisely identify and segment objects 131 in images 130 that are included in videos 135. The UVOS functions 171 can generally be configured to target any type of object included in the images 130. In certain embodiments, the UVOS functions 171 aim to target objects 131 that appear prominently in scenes captured in the videos 135 or images 130, and/or which are located in foreground regions of the videos 135 or images 130. Likewise, certain examples discussed below describe embodiments in which the computer vision system 150 is configured to perform IOCS functions 172 to precisely identify and segment objects 131 in images 130 that are associated with one or more predetermined semantic classes or categories. For example, upon receiving a collection of images 130, the computer vision system 150 may analyze each of the images 130 to identify and extract objects 131 that are in a particular semantic class or category (e.g., human category, car category, plane category, etc.).

The images 130 received by the computer vision system 150 can be provided to the neural network architecture 140 for processing and/or analysis. In certain embodiments, the neural network architecture 140 may comprise a convolutional neural network (CNN), or a plurality of convolutional neural networks. Each CNN may represent an artificial neural network (e.g., which may be inspired by biological processes), and may be configured to analyze images 130 and/or videos 135, and to execute deep learning functions and/or machine learning functions on the images 130 and/or videos 135. Each CNN may include a plurality of layers including, but not limited to, one or more input layers, one or more output layers, one or more convolutional layers (e.g., that include learnable filters), one or more ReLU (rectifier linear unit) layers, one or more pooling layers, one or more fully connected layers, one or more normalization layers, etc. The configuration of the CNNs and their corresponding layers enable the CNNs to learn and execute various functions for analyzing, interpreting, and understanding the images 130 and/or videos 135. Exemplary configurations of the neural network architecture 140 are discussed in further detail below.

In certain embodiments, the neural network architecture 140 can be trained to perform one or more computer vision functions to analyze the images 130 and/or videos 135. For example, the neural network architecture 140 can analyze an image 130 (e.g., which may or may not be included in a video 135) to perform object segmentation functions 170, which may include UVOS functions 171, IOCS functions 172, and/or other types of segmentation functions 170. In certain embodiments, the object segmentation functions 170 can identify the locations of objects 131 with pixel-level accuracy. The neural network architecture 140 can additionally analyze the images 130 and/or videos 135 to perform other computer vision functions (e.g., object classification, object counting, re-identification, and/or other functions).

The neural network architecture 140 of the computer vision system 150 can be configured to generate and output segmentation results 160 based on an analysis of the images 130 and/or videos 135. The segmentation results 160 for an image 130 and/or video 135 can generally include any information or data associated with analyzing, interpreting, and/or identifying objects 131 included in the images 130 and/or video 135. In certain embodiments, the segmentation results 160 can include information or data that indicates the results of the computer vision functions performed by the neural network architecture 140. For example, the segmentation results 160 may include information that identifies the results associated with performing the object segmentation functions 170 including UVOS functions 171 and IOCS functions 172.

In certain embodiments, the segmentation results 160 can include information that indicates whether or not one or more target objects 131 were detected in each of the images 130. For embodiments that perform UVOS functions 171, the one or more target objects 131 may include objects 131 located in foreground portions of the images 130 and/or prominent objects 131 captured in the images 130. For embodiments that perform IOCS functions 172, the one or more target objects 131 may include objects 131 that are included in one or more predetermined classes or categories.

The segmentation results 160 can include data that indicates the locations of the objects 131 identified in each of the images 130. For example, the segmentation results 160 for an image 130 can include an annotated version of an image 130, which identifies each of the objects 131 (e.g., humans, vehicles, structures, animals, etc.) included in the image using a particular color, and/or which includes lines or annotations surrounding the perimeters, edges, or boundaries of the objects 131. In certain embodiments, the objects 131 may be identified with pixel-level accuracy. The segmentation results 160 can include other types of data or information for identifying the locations of the objects 131 (e.g., such as coordinates of the objects 131 and/or masks identifying locations of objects 131). Other types of information and data can be included in the segmentation results 160 output by the neural network architecture 140 as well.

In certain embodiments, the neural network architecture 140 can be trained to perform these and other computer vision functions using any supervised, semi-supervised, and/or unsupervised training procedure. In certain embodiments, the neural network architecture 140, or portion thereof, is trained using an unsupervised training procedure. In certain embodiments, the neural network architecture 140 can be trained using training images that are annotated with pixel-level ground-truth information. One or more loss functions may be utilized to guide the training procedure applied to the neural network architecture 140.

In the exemplary system 100 of FIG. 1, the computer vision system 150 may be stored on, and executed by, the one or more servers 120. In other exemplary systems, the computer vision system 150 can additionally, or alternatively, be stored on, and executed by, the computing devices 110 and/or other devices. The computer vision system 150 can additionally, or alternatively, be integrated into an image capturing device that captures the images 130 and/or videos 135, thus enabling the image capturing device to analyze the images 130 and/or videos 135 using the techniques described herein. Likewise, the computer vision system 150 can also be stored as a local application on a computing device 110, or integrated with a local application stored on a computing device 110 to implement the techniques described herein. For example, in certain embodiments, the computer vision system 150 can be integrated with (or can communicate with) various applications including, but not limited to, image editing applications, video editing applications, surveillance applications, and/or other applications that are stored on a computing device 110 and/or server 120.

In certain embodiments, the one or more computing devices 110 can enable individuals to access the computer vision system 150 over the network 190 (e.g., over the Internet via a web browser application). For example, after an image capturing device has captured one or more images 130 or videos 135, an individual can utilize the image capturing device or a computing device 110 to transmit the one or more images 130 or videos 135 over the network 190 to the computer vision system 150. The computer vision system 150 can analyze the one or more images 130 or videos 135 using the techniques described in this disclosure. The segmentation results 160 generated by the computer vision system 150 can be transmitted over the network 190 to the image capturing device and/or computing device 110 that transmitted the one or more images 130 or videos 135.

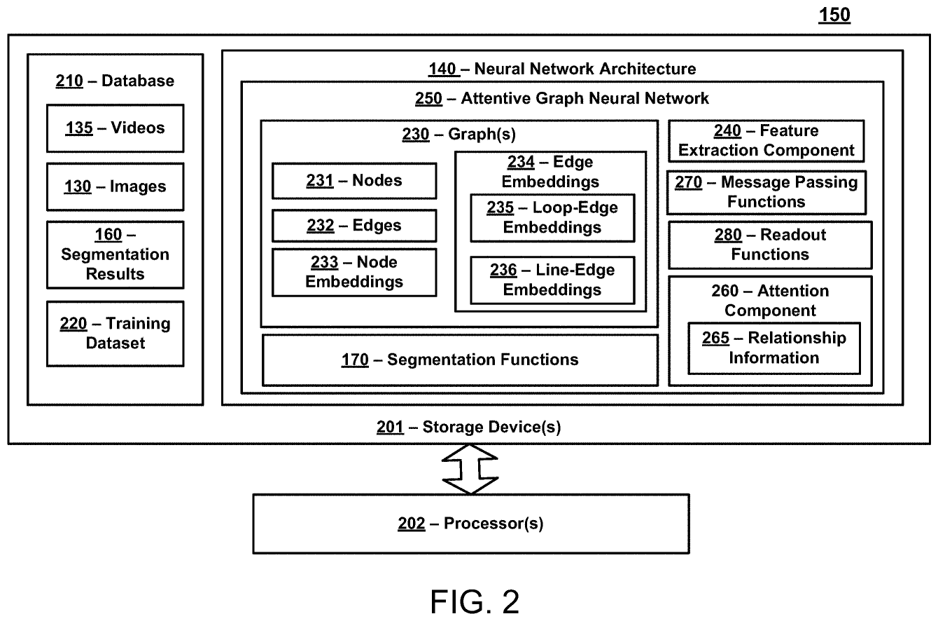

FIG. 2 is a block diagram of an exemplary computer vision system 150 in accordance with certain embodiments. The computer vision system 150 includes one or more storage devices 201 that are in communication with one or more processors 202. The one or more storage devices 201 can include: (i) non-volatile memory, such as, for example, read-only memory (ROM) or programmable read-only memory (PROM); and/or (ii) volatile memory, such as, for example, random access memory (RAM), dynamic RAM (DRAM), static RAM (SRAM), etc. In these or other embodiments, storage devices 201 can comprise (i) non-transitory memory and/or (ii) transitory memory. The one or more processors 202 can include one or more graphics processing units (CPUs), central processing units (CPUs), controllers, microprocessors, digital signal processors, and/or computational circuits. The one or more storage devices 201 can store data and instructions associated with one or more databases 210 and a neural network architecture 140 that comprises attentive graph neural network 250. Each of these components, as well as their sub-components, is described in further detail below.

The database 210 stores the images 130 (e.g., video frames or other images) and videos 135 that are provided to and/or analyzed by the computer vision system 150, as well as the segmentation results 160 that are generated by the computer vision system 150. The database 210 can also store a training dataset 220 that is utilized to train the neural network architecture 140. Although not shown in FIG. 2, the database 210 can store any other data or information mentioned in this disclosure including, but not limited to, graphs 230, nodes 231, edges 232, node representations 233, edge representations 234, etc.

The training dataset 220 may include images 130 and/or videos 135 that can be utilized in connection with a training procedure to train the neural network architecture 140 and its subcomponents (e.g., the attentive graph neural network 250, feature extraction component 240, attention component 260, message passing functions 270, and/or readout functions 280). The images 130 and/or videos 135 included in the training dataset 220 can be annotated with various ground-truth information to assist with such training. For example, in certain embodiments, the annotation information can include pixel-level labels and/or pixel-level annotations identifying the boundaries and locations of objects 131 in the images or video frames included in the training dataset 220. In certain embodiments, the annotation information can additionally, or alternatively, include image-level and/or object-level annotations identifying the objects 131 in each of the training images. In certain embodiments, some or all of the images 130 and/or videos 135 included in the training dataset 220 may be obtained from one more public datasets, e.g., such as the MSRA10k dataset, DUT dataset, and/or DAVIS2016 dataset.

The neural network architecture 140 can be trained to perform segmentation functions 170, such as UVOS functions 171 and IOCS functions 172, and other computer vision functions. In certain embodiments, the neural network architecture 140 includes an attentive graph neural network 250 that enables the neural network architecture 140 to perform the segmentation functions 170. The configurations and implementations of the neural network architecture 140, including the attentive graph neural network 250, feature extraction component 240, attention component 260, message passing functions 270, and/or readout functions 280, can vary.

The AGNN 250 can be configured to construct, generate, or utilize graphs 230 to facilitate performance of the UVOS functions 171 and IOCS functions 172. Each graph 230 may be comprised of a plurality of nodes 231 and a plurality of edges 232 that interconnect the nodes 231. The graphs 230 constructed by the AGNN 250 may be fully connected graphs 230 in which every node 231 is connected via an edge 232 to every other node 231 included in the graph 230. Generally speaking, the nodes 231 of a graph 230 may be used to represent video frames or images 130 of a video 135 (or other collection of images 130) and the edges 232 may be used to represent correlation or relationship information 265 between arbitrary node pairs included in the graph 230. The correlation or relationship information 265 can be used by the AGNN 250 to improve the performance and accuracy of the segmentation functions 170 (e.g., UVOS functions 171 and/or IOCS functions 172) executed on the images 130.

A feature extraction component 240 can be configured to extract node embeddings 233 (also referred to herein as “node representations”) for each of the images 130 or frames that are input or provided to the computer vision system 150. In certain embodiments, the feature extraction component 240 may be implemented, at least in part, using a CNN-based segmentation architecture, such as DeepLabV3 or other similar architecture. The node embeddings 233 extracted from the images 130 using the feature extraction component 240 comprise feature information associated with the corresponding image. For each input video 135 or input collection of images 130 received by the computer vision system 150, AGNN 250 may utilize the feature extraction component 240 to extract node embeddings 233 from the corresponding images 130 and may construct a graph 230 in which each of the node embeddings 233 are associated with a separate node 231 of a graph 230. The node embeddings 233 obtained using the feature extraction component 240 may be utilized to represent the initial state of the nodes 231 included in the graph 230.

Each node 231 in a graph 230 is connected to every other node 231 via a separate edge 232 to form a node pair. An attention component 260 can be configured to generate an edge embedding 234 for each edge 232 or node pair included the graph 230. The edge embeddings 234 capture or include the relationship information 265 corresponding to node pairs (e.g., correlations between the node embeddings 233 and/or images 130 associated with each node pair).

The edge embeddings 234 extracted or derived using the attention component 260 can include both loop-edge embeddings 235 and line-edge embeddings 236. The loop-edge embeddings 235 are associated with edges 232 that connect nodes 231 to themselves, while the line-edge embeddings 236 are associated with edges 232 that connect node pairs comprising two separate nodes 231. The attention component 260 extracts intra-node relationship information 265 comprising internal representations of each node 231, and this intra-node relationship information 265 is incorporated into the loop-edge embeddings 235. The attention component 260 also extracts inter-node relationship information 265 comprising bi-directional or pairwise relations between two nodes, and this inter-node relationship information 265 is incorporated into the line-edge embeddings 236. As explained in further detail below, both the loop-edge embeddings 235 and the line-edge embeddings 236 can be used to update the initial node embeddings 233 associated with the nodes 231.

A message passing function 270 utilizes the relationship information 265 associated with the edge embeddings 234 to update the node embeddings 233 associated with each node 231. For example, in certain embodiments, the message passing function 270 can be configured to recursively propagate messages over a predetermined number of iterations to mine or extract rich relationship information 265 among images 130 included in a video 135 or dataset. Because portions of the images 130 or node embeddings 233 associated with certain nodes 231 may be noisy (e.g., due to camera shift or out-of-view objects), the message passing function 270 utilizes a gating mechanism to filter out irrelevant information from the images 130 or node embeddings 233. In certain embodiments, the gating mechanism generates a confidence score for each message and suppresses messages that have low confidence (e.g., thus, indicating that the corresponding message is noisy). The node embeddings 233 associated with the AGNN 250 are updated with at least a portion of the messages propagated by the message passing function 270. The messages propagated by the message passing function 270 enable the AGNN 250 to capture the video content and/or image content from a global view, which can be useful for obtaining more accurate foreground estimates and/or identifying semantically-related images.

After the message passing function 270 propagates messages over the graph 230 to generate updated node embeddings 233, a readout function 280 maps the updated node embeddings 233 to final segmentation results 160. The segmentation results 160 may comprise segmentation predictions maps or masks that identify the results of segmentation functions 170 performed using the neural network architecture 140.

Exemplary embodiments of the computer vision system 150 and the aforementioned sub-components (e.g., the database 210, neural network architecture 140, feature extraction component 240, AGNN 250, attention component 260, message passing functions 270, and readout functions 280) are described in further detail below. While the sub-components of the computer vision system 150 may be depicted in FIG. 2 as being distinct or separate from one another, it should be recognized that this distinction may be a logical distinction rather than a physical or actual distinction. Any or all of the sub-components can be combined with one another to perform the functions described herein, and any aspect or feature that is described as being performed by one sub-component can be performed by any or all of the other sub-components. Also, while the sub-components of the computer vision system 150 may be illustrated as being implemented in software in certain portions of this disclosure, it should be recognized that the sub-components described herein may be implemented in hardware and/or software.

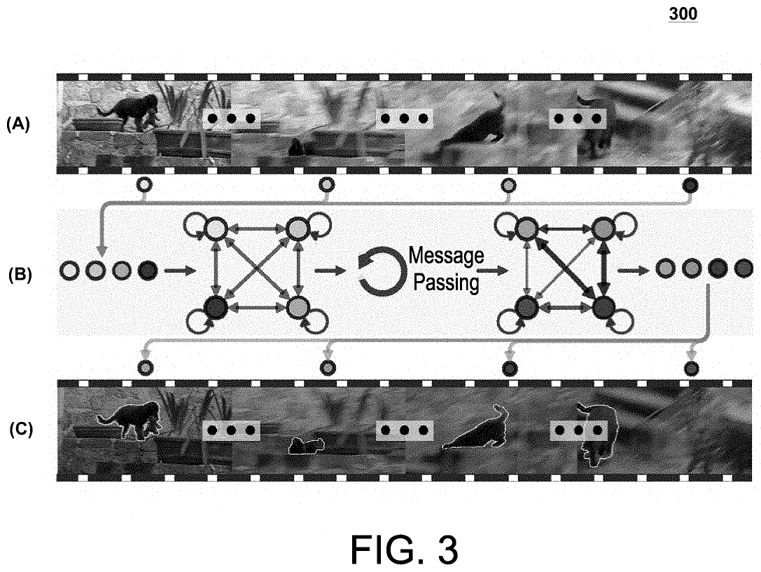

FIG. 3 is a diagram illustrating an exemplary process flow 300 for performing UVOS functions 171 in accordance with certain embodiments. In certain embodiments, this exemplary process flow 300 may be executed by the computer vision system 150 or neural network architecture 140, or certain portions of the computer vision system 150 or neural network architecture 140.

At Stage A, a video sequence 135 is received by the computer vision system 150 that comprises a plurality of frames 130. For purposes of simplicity, the video sequence 135 only comprises four images or frames 130. However, it should be recognized that the video sequence 135 can include any number of images or frames (e.g., hundreds, thousands, and/or millions of frames). As with many typical video sequences 135, the target object 131 (e.g., the animal located in the foreground portions) in the video sequence experiences occlusions and scale variations across the frames 130.

At Stage B, the frames of the video sequence are represented as nodes 231 (shown as blue circles) in a fully-connected AGNN 250. Every node 231 is connected to every other node 231 and itself via a corresponding edge 232. A feature extraction component 240 (e.g., DeepLabV3) can be utilized to generate an initial edge embedding 234 for each frame 235 which can be associated with a corresponding node 231. The edges 232 represent the relations between the node pairs (which may include inter-node relations between two separate nodes or intra-node relations in which an edge 232 connects the node 231 to itself). An attention component 260 captures the relationship information 265 between the node pairs and associates corresponding edge embeddings 234 with each of the edges 232. A message passing function 270 performs several message passing iterations to update the initial node embeddings 233 to derive updated node embeddings 233 (shown as red circles). After several message passing iterations are complete, better relationship information and more optimal foreground estimations can be obtained from the updated node embeddings which provides a more global view.

At Stage C, the updated node embeddings 233 are mapped to segmentation results 160 (e.g., using the readout function 280). The segmentation results 160 can include annotated versions of the original frames 130 that include boundaries identifying precise locations of the target object 131 with pixel-level accuracy.

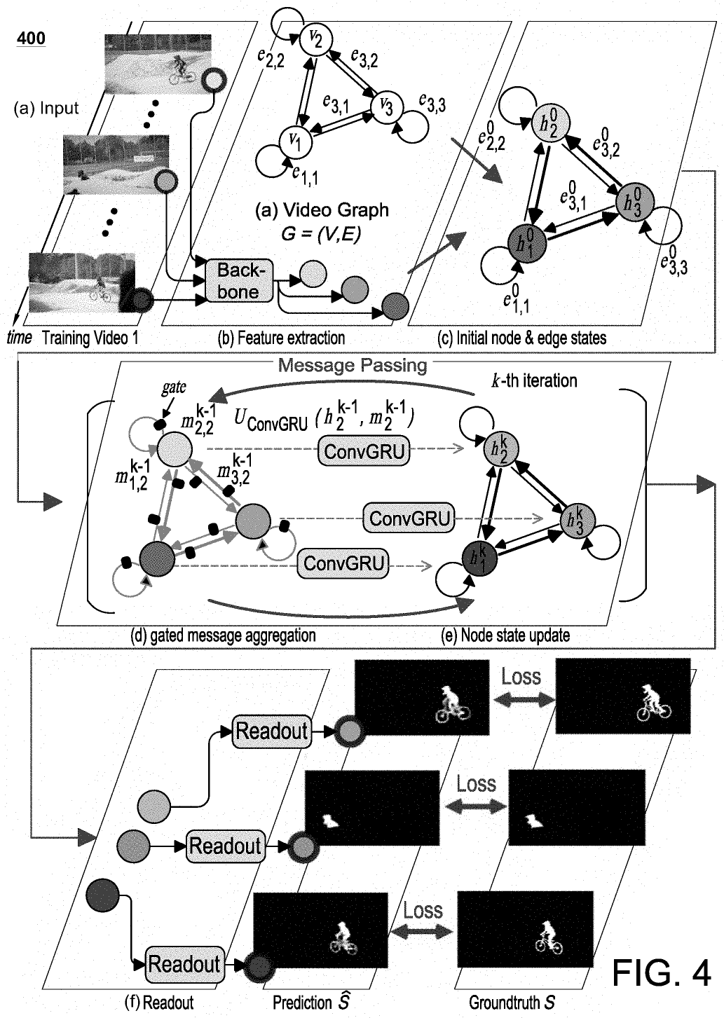

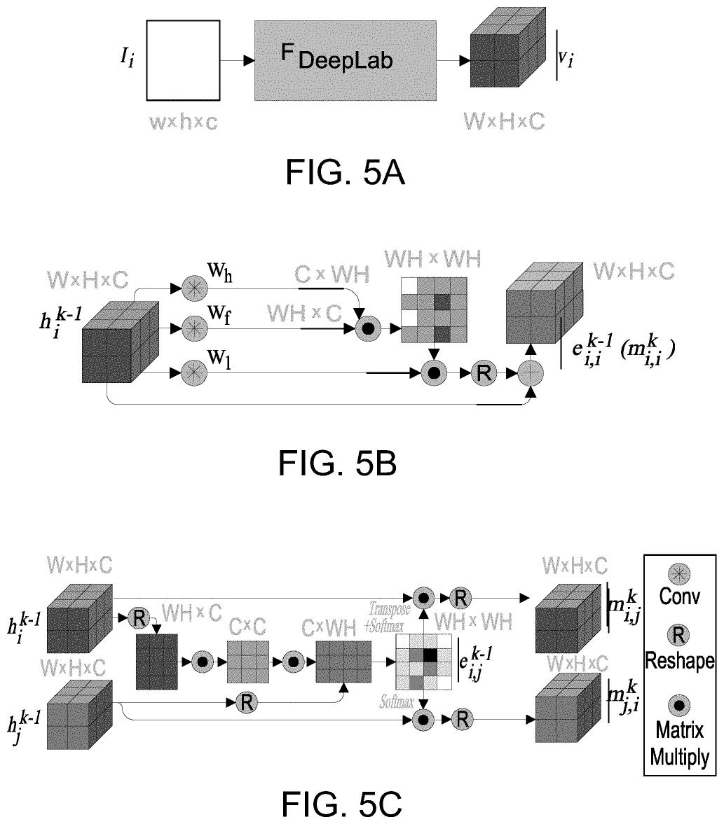

FIG. 4 is a diagram illustrating an exemplary architecture 400 for training a computer vision system 150 or neural network architecture 140 to perform UVOS functions 171 in accordance with certain embodiments. As shown, the exemplary architecture 400 can be divided into the following stages: (a) an input stage that receives a video sequence 135; (b) a feature extraction stage in which a feature extraction component 240 (labeled “backbone”) extracts node embeddings 233 from the images of the video sequence 135; (c) an initialization stage in which the node and edge states are initialized; (d) a gated, message aggregation stage in which a message passing function 270 propagates messages among the nodes 231; (e) an update stage for updating node embeddings 233; and (f) a readout stage that maps the updated node embeddings 233 to final segmentation results 160. FIGS. 5A-C show exemplary architectures for implementing aspects and details for several of these stages.

Before elaborating on each of the above stages, a brief introduction is provided related to generic formulations of graph neural network (GNN) models. Based on deep neural network and graph theory, GNNs can be a powerful tool for collectively aggregating information from data represented in graph domain. A GNN model can be defined according to a graph [symbol] =(V, ε). Each node vᵢ∈V can be assigned a unique value from {1, . . . , |V|}, and can be associated with an initial node embedding (233) vᵢ (also referred to as an initial “node state” or “node representation”). Each edge e_{i,j}∈ε represents a pair e_{i,j}=(vᵢ,vⱼ)∈|V|×|V|, and can be associated with an edge embedding (234) e_{i,j} (also referred to as an “edge representation”). For each node vᵢ, an updated node representation hᵢ can be learned through aggregating embeddings or representations of its neighbors. Here, hᵢ is used to produce an output oᵢ, e.g., a node label. More specifically, GNNs may map graph [symbol] to the node outputs {oᵢ}ᵢ₌₁^{|V|} through two phases. First, a parametric message passing phase can be executed for K steps (e.g., using the message passing function 270). The parametric message passing technique recursively propagates messages and updates node embeddings 233. At the k-th iteration, for each node vᵢ, its state is updated according to its received message mᵢ^{k} (e.g., summarized information from its neighbors [symbol] ) and its previous state hᵢ^{k-1} as follows:

message aggregation:

$$\begin{matrix}{m}_{i}^{k} = {Σ}_{vj ∈ {𝒩}_{i}} {m}_{j , i}^{k} , \\ = {Σ}_{vj ∈ {𝒩}_{i}} M ( {h}_{j}^{k - 1} , {e}_{i , j}^{k - 1} ) ,\end{matrix}$$

node representation update: hᵢ^{k}=U(hᵢ^{k-1},mᵢ^{k}), (1)

where hᵢ⁰=vᵢ,M(⋅) and U(⋅) are message function and state update function, respectively. After k iterations of aggregation, hᵢ^{k} captures the relations within k-hop neighborhood of nodevᵢ.

Next, a readout phase maps the node representation hᵢ^{K} of the final K-iteration to a node output through a readout function R(⋅) as follows:

readout:oᵢ=R(hᵢ^{K}). (2)

The message function M, update function U, and readout function R can all represent learned differentiable functions.

The AGNN-based UVOS solution described herein extends such fully connected GNNs to preserve spatial features and to capture pair-wise relationship information 265 (associated with the edges 232 or edge embeddings 234) via a differentiable attention component 260.

Given an input video [symbol] ={Iᵢ∈ [symbol] ^{w×h×3}}ᵢ₌₁^{N} with N frames in total, one goal of an exemplary UVOS function 171 may be to generate a corresponding sequence of binary segment masks: [symbol] ={Sᵢ∈{0,1}^{w×h}}ᵢ₌₁^{N}, without any human interaction. To achieve this, AGNN 250 may represent the video [symbol] as a directed graph [symbol] =(V,ε), where node vᵢEV represents the i-th frame Iᵢ, and edge e_{i,j}=(vᵢ, vⱼ)∈ε indicates the relation from Iᵢ to Iⱼ. To comprehensively capture the underlying relationships between video frames, it can be assumed that [symbol] is fully-connected and includes self-connections at each node 231. For clarity, the notation e_{i,i} is used to describe an edge 232 that connects a node vᵢ to itself as a “loop-edge,” and the notation e_{i,j} is used to describe an edge 232 that connects two different nodes vᵢ and vⱼ as a “line-edge.”

The AGNN 250 utilizes a message passing function 270 to perform K message propagation iterations over [symbol] to efficiently mine rich and high-order relations within [symbol] . This helps to better capture the video content from a global view and to obtain more accurate foreground estimates. The AGNN 250 utilizes a readout function 280 to read out the segmentation predictions [symbol] from the final node states {hᵢ^{K}}ᵢ₌₁^{N}. Various components of the exemplary neural network architectures illustrated in FIGS. 4 and 5A-5C are described in further details below.

Node Embedding: In certain embodiments, a classical FCN based semantic segmentation architecture, such as DeepLabV3, may be utilized to extract effective frame features as node embeddings 233. For node vᵢ, its initial embedding hᵢ⁰ can be computed as:

hᵢ⁰=vᵢ=F_{DeepLab}(Iᵢ)∈ [symbol] ^{W×H×C}, (3)

where hᵢ⁰ is a 3D tensor feature with W×H spatial resolution and C channels, which preserves spatial information as well as high-level semantic information. FIG. 5A is a diagram illustrating how an exemplary feature extraction component 240 may be utilized to generate the initial node embeddings 233 for use in the AGNN 250.

Intra-Attention Based Loop-Edge Embedding: A loop-edge e_{i,j}∈ε is an edge that connects a node to itself. The loop-edge embedding (235) e_{i,i}^{k} is used to capture the intra-relations within node representation hᵢ^{k} (e.g., internal frame representation). The loop-edge embedding 235 can be formulated as an intra-attention mechanism, which can be complementary to convolutions and helpful for modeling long-range, multi-level dependencies across image regions. In particular, the intra-attention mechanism may calculate the response at a position by attending to all the positions within the same node embedding as follows:

$$\begin{matrix}{e}_{i , i}^{k} = {F}_{i n t r a - a t t} ( {h}_{i}^{k} ) ϵ {ℝ}^{W \times H \times C} \\ = α softmax ( ( {W}_{f} * {h}_{i}^{k} ) {( {W}_{h} * {h}_{i}^{k} )}^{T} ) ( {W}_{l} * {h}_{i}^{k} ) + {h}_{i}^{k} ,\end{matrix} \qquad ( 4 )$$

where “*” represents the convolution operation, Ws indicate learnable convolution kernels, and a is a learnable scale parameter. Equation 4 causes the output element of each position in hᵢ^{k} to encode contextual information as well as its original information, thus enhancing the representative capability. FIG. 5B is a diagram illustrating how an exemplary attention component 260 may be utilized to generate the loop-edge embedding 235 for use in the AGNN 250.

Inter-Attention Based Line-Edge Embedding: A line-edge eᵢⱼ∈ε connects two different nodes vᵢ and vⱼ. The line-edge embedding (236) e_{i,j}^{k} is used to mine the relation from node vᵢ to vⱼ, in the node embedding space. An inter-attention mechanism can be used to capture the bi-directional relations between two nodes vᵢ and vⱼ as follows:

e_{i,j}^{k}=Fᵢₙₜᵣₐ₋ₐₜₜ(hᵢ^{k},hⱼ^{k})=hᵢ^{k}W_{c}hⱼ^{kT}∈ [symbol] ^{(WH)×(WH)},

e_{j,i}^{k}=Fᵢₙₜᵣₐ₋ₐₜₜ(hⱼ^{k},hᵢ^{k})=hⱼ^{k}W_{c}^{T}hᵢ^{kT}∈ [symbol] ^{(WH)×(WH)}, (5)

where e_{i,j}^{k}=e_{j,i}^{kT}. e_{i,j}^{k} indicates the outgoing edge feature, and e_{j,i}^{k} the incoming edge feature, for node vᵢ. W_{c}∈ [symbol] ^{C×C} indicates a learnable weight matrix. hⱼ^{k}∈ [symbol] ^{(WH)×C} and hᵢ^{k}∈ [symbol] ^{(WH)×C} can be flattened into matrix representations. Each element in e_{i,j}^{k} reflects the similarity between each row of hᵢ^{k} and each column of hⱼ^{kT}. As a result, e_{i,j}^{k} can be viewed as the importance of node vᵢ's embedding to vⱼ, and vice versa. By attending to each node pair, e_{i,j}^{k} explores their joint representations in the node embedding space. FIG. 5C is a diagram illustrating how an exemplary attention component 260 may be utilized to generate the line-edge embedding 236 for use in the AGNN 250.

Gated Message Aggregation: In the AGNN 250, for the messages passed in the self-loop, the loop-edge embedding e_{i,j}^{k-1} itself can be viewed as a message (see FIG. 5B) because it already contains the contextual and original node information (see Equation 4):

m_{i,i}^{k}=e_{i,i}^{k-1}∈ [symbol] ^{W×H×C} (6)

For the message m_{j,i} passed from node vⱼ to vᵢ (see FIG. 5C), the following can be used:

m_{j,i}^{k}=M(hⱼ^{k-1},e_{i,j}^{k-1})=softmax(e_{i,j}^{k-1})hⱼ^{k-1}∈ [symbol] ^{(WH)×C} (7)

where softmax(⋅) normalizes each row of the input. Thus, each row (position) of m_{j,i}^{k} is a weighted combination of each row (position) of hⱼ^{k-1} where the weights are obtained from the corresponding column of e_{i,j}^{k-1}. In this way, message function M(⋅) assigns its edge-weighted feature (i.e., message) to the neighbor nodes. Then, m_{j,i}^{k} can be reshaped back to a 3D tensor with a size of W×H×C.

In addition, considering the situations in which some nodes 231 are noisy (e.g., due to camera shift or out-of-view objects), the messages associated with these nodes 231 may be useless or even harmful. Therefore, a learnable gate G(⋅) can be applied to measure the confidence of a message m_{j,i} as follows:

g_{j,i}^{k}=G(m_{j,i}^{k})=σ(F_{GAP}(W_{g}*m_{j,i}^{k}+b_{g}))∈[0,1]^{C}, (8)

where F_{GAP} refers to global average pooling utilized to generate channel-wise responses, σ is the logistic sigmoid function σ(x)=1/(1+exp(−x)), and W_{g} and b_{g} are the trainable convolution kernel and bias.

Per Equation 1, the messages from the neighbors and self-loop via gated summarization (see stage (d) of FIG. 4) can be reformulated as:

mᵢ^{k}=Σ_{vj∈V}g_{j,i}^{k}*m_{j,i}^{k}∈ [symbol] ^{W×H×C}, (9)

where “*” denotes channel-wise Hadamard product. Here, the gate mechanism is used to filter out irrelevant information from noisy frames.

ConvGRU based Node-State Update: In step k, after aggregating all information from the neighbor nodes and itself (see Equation 9), vᵢ is assigned a new state hᵢ^{k} by taking into account its prior state hᵢ^{k-1} and its received message mᵢ^{k}. To preserve the spatial information conveyed in hᵢ^{k-1} and mᵢ^{k}, ConvGRU can be leveraged to update the node state (e.g., as in stage (e) of FIG. 4) as follows:

hᵢ^{k}=U_{ConvGRU}(hᵢ^{k-1},mᵢ^{k})∈ [symbol] ^{W×H×C}. (10)

ConvGRU can be used as a convolutional counterpart of previous fully connected gated recurrent unit (GRU), by introducing convolution operations into input-to-state and state-to-state transitions.

Readout Function: After K message passing iterations, the final state hᵢ^{k} for each node vᵢ can be obtained. In the readout phase, a segmentation prediction map Ŝᵢ∈[0,1]^{W×H} can be obtained from hᵢ^{k} through a readout function R(⋅) (see stage (f) of FIG. 4). Slightly different from Equation 2, the final node state hᵢ^{k} and the original node feature vᵢ (i.e., hᵢ⁰) can be concatenated together and provided to the combined feature into R(⋅) as follows:

Ŝᵢ=R_{FCN}([hᵢ^{K},vᵢ])∈[0,1]^{W×H}. (11)

Again, to preserve spatial information, the readout function 280 can be implemented as a relatively small fully convolutional network (FCN), which has three convolution layers with a sigmoid function to normalize the prediction to [0, 1]. The convolution operations in the intra-attention (Equation 4) and update function (Equation 10) can be implemented with 1×1 convolutional layers. The readout function (Equation 11) can include two 3×3 convolutional layers cascaded by a 1×1 convolutional layer. As a message passing-based GNN model, these functions can share weights among all the nodes. Moreover, all the above functions can be carefully designed to avoid disturbing spatial information, which can be important for UVOS because it is typically a pixel-wise prediction task.

In certain embodiments, the neural network architecture 140 is trainable end-to-end, as all the functions in AGNN 250 are parameterized by neural networks. The first five convolution blocks of DeepLabV3 may be used as the backbone or feature extraction component 240 for feature extraction. For an input video I, each frame Iᵢ (e.g., with a resolution of 473×473) can be represented as a node vᵢ in the video graph g and associated with an initial node state vᵢ=hᵢ⁰∈ [symbol] ^{60×60×256}. Then, after K message passing iterations, the readout function 280 in Equation 11 can be used to obtain a corresponding segmentation prediction map Ŝ∈[0,1]^{60×60} for each node vᵢ. Further details regarding the training and testing phases of the neural network architecture 140 are provided below.

Training Phase: As the neural network architecture 140 may operate on batches of a certain size (which is allowed to vary depending on the GPU memory size), a random sampling strategy can be utilized to train AGNN. For each training video I with total N frames, the video I can be split into N′ segments (N′≤N) and one frame can be randomly selected from each segment. The sampled N′ frames can be provided into a batch to train the AGNN 250. Thus, the relationships among all the N′ sampling frames in each batch are represented using an N′-node graph. Such sampling strategy provides robustness to variations and enables the network to fully exploit all frames. The diversity among the samples enables our model to better capture the underlying relationships and improve the generalization ability of the neural network architecture 140.

The ground-truth segmentation mask and predicted foreground map for a training frame Iᵢ can be denoted as S∈[0,1]^{60×60} and Ŝ∈[0,1]^{60×60}. The AGNN 150 can be trained through a weighted binary cross entropy loss as follows:

[symbol]

(S,Ŝ)=−Σₓ^{W×H}(1−η)Sₓ log(Ŝₓ)+η(1−Sₓ)log(1−Ŝₓ), (12)

where η indicates the foreground-background pixel number ratio in S. It can be noted that, as AGNN handles multiple video frames at the same time, it leads to a remarkably efficient training data augmentation strategy, as the combination of candidates are numerous. In certain experiments that were conducted, two videos were randomly selected from the training video set and three frames (N′=3) per video were sampled during training due to the computational limitations. In addition, the number of total iterations was set as K=3.

Testing Phase: After training, the learned AGNN 250 can be applied to perform per-pixel object prediction over unseen videos. For an input test video I with N frames (with 473×473 resolution), video I is split into T subsets: {I₁, I₂, . . . , I_{T}}, where T=N/N′. Each subset contains N′ frames with an interval of T frames: I_{τ}={I_{τ}, I_{τ+T}, . . . , IN₋T₊t}. Then each subset can then be provided to the AGNN 250 to obtain the segmentation maps of all the frames in the subset. In practice, N′=5 was set during testing. As the AGNN 250 does not require time-consuming optical flow computation and processes N′ frames in one feed-forward propagation, it achieves a fast speed of 0.28 s per frame. Conditional random fields (CRF) can be applied as a post-processing step, which takes about 0.50 s per frame to process.

IOCS Implementation Details: The AGNN model described herein can be viewed as a framework to capture the high-order relations among images or frames. This generality can further be demonstrated by extending the AGNN 250 to perform IOCS functions 172 as mentioned above. Rather than extracting the foreground objects across multiple relatively similar video frames, the AGNN 250 can be configured to infer common objects from a group of semantic-related images to perform IOCS functions 172.

Training and testing can be performed using two well-known IOCS datasets: PASCAL VOC dataset and the Internet dataset. Other datasets may also be used. In certain embodiments, a portion of the PASCAL VOC dataset can be used to train the AGNN 250. In each iteration, a group of N′=3 images can be sampled that belong to the same semantic class, and two groups with randomly selected classes (e.g., totaling 6 images) can be fed to the AGNN 250. All other settings can be the same as the UVOS settings described above.

After training, the performance of the IOCS functions 172 may leverage the information from the whole image group (as the images are typically different and contain a few irrelevant ones) when processing an image. To this end, for each image Iᵢ to be segmented, the other N−1 images may be uniformly split into T groups, where T=(N−1)/(N′−1). The first image group and Iᵢ can be provided to a batch with N′ size, and the node state of Iᵢ can be stored. After that, the next image group is provided and the node state of Iᵢ is stored to obtain a new state of Iᵢ. After T steps, the final state of Iᵢ includes its relations to all the other images and may be used to produce its final co-segmentation results.

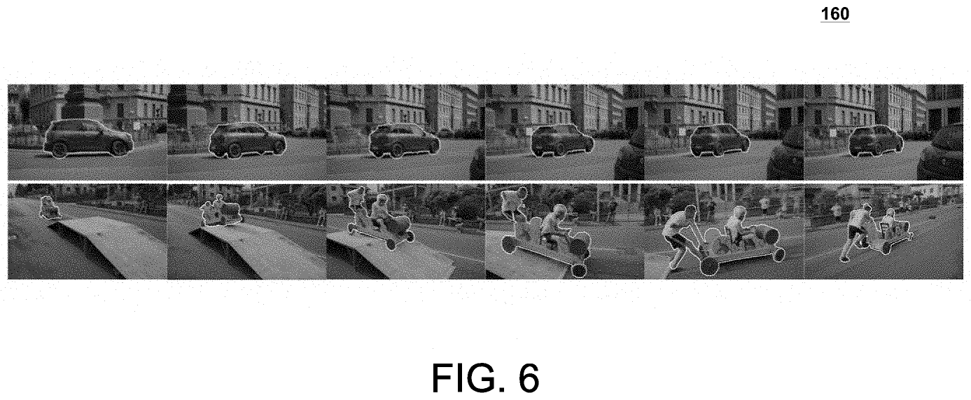

FIG. 6 is a table illustrating exemplary segmentation results 160 generated by UVOS functions 171 according to an embodiment of the neural network architecture 140. The segmentation results 160 were generated on two challenging video sequences included in the DAVIS2016 dataset: (1) a car-roundabout video sequence shown in the top row; and (2) a soapbox video sequence shown in the bottom row. The segmentation results 160 are able to identify the primary target objects 131 across the frames of these video sequences. The target objects 131 identified by the UVOS functions 171 are highlighted in green.

Around the 55th frame of car-roundabout video sequence (top row), another object (i.e., a red car) enters the video, which can create a potential distraction from the primary object. Nevertheless, the AGNN 250 is able discriminate the foreground target in spite of the distraction by leveraging multi-frame information. For soap-box video sequence (bottom row), the primary objects undergo huge scale variation, deformation, and view changes. Once again, the AGNN 250 is still able to generate accurate foreground segments by leveraging multi-frame information.

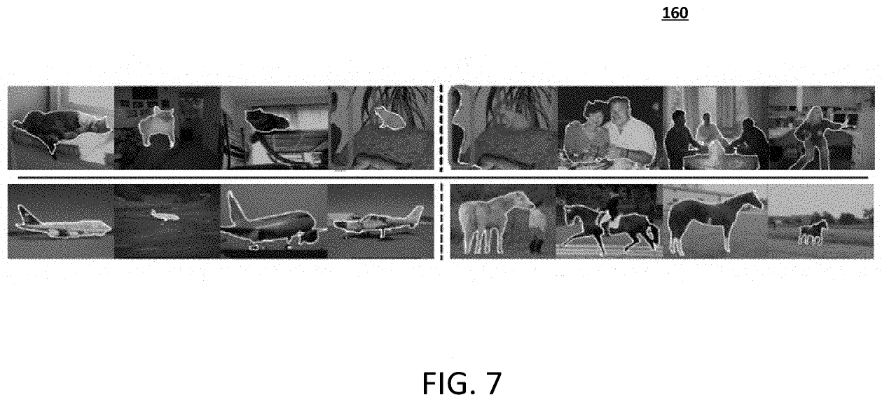

FIG. 7 is a table illustrating exemplary segmentation results 160 generated by IOCS functions 172 according to an embodiment of the neural network architecture 140. Here, the segmentation results demonstrate that the AGNN 250 is able to identify target objects 131 within particular semantic classes.

The first four images in the top row belong to the “cat” category while the last four images belong to the “person” category. Despite significant intra-class variation, substantial background clutter, and partial occlusion of target objects 131, the AGNN 250 is able to leverage multi-image information to accurately identify the target objects 131 belonging to each semantic class. For the bottom row, the first four images belong to the “airplane” category while the last four images belong to the “horse” category. Again, the AGNN 250 demonstrates that it performs well in cases with significant intra-class appearance change.

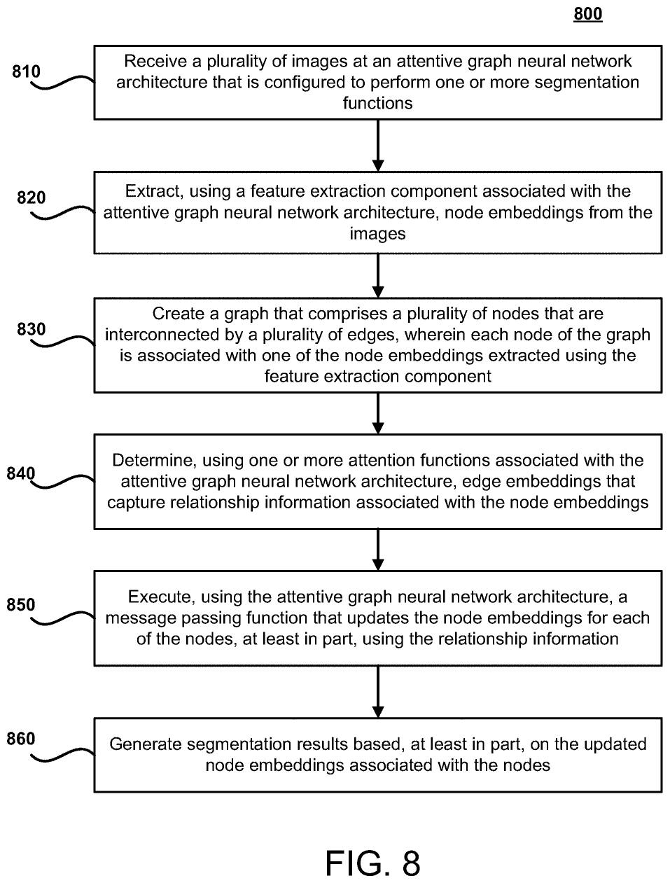

FIG. 8 illustrates a flow chart for an exemplary method 800 according to certain embodiments. Method 800 is merely exemplary and is not limited to the embodiments presented herein. Method 800 can be employed in many different embodiments or examples not specifically depicted or described herein. In some embodiments, the steps of method 800 can be performed in the order presented. In other embodiments, the steps of method 800 can be performed in any suitable order. In still other embodiments, one or more of the steps of method 800 can be combined or skipped. In many embodiments, computer vision system 150, neural network architecture 140, and/or architecture 400 can be suitable to perform method 800 and/or one or more of the steps of method 800. In these or other embodiments, one or more of the steps of method 800 can be implemented as one or more computer instructions configured to run on one or more processing modules (e.g., processor 202) and configured to be stored at one or more non-transitory memory storage modules (e.g., storage device 201). Such non-transitory memory storage modules can be part of a computer system, such as computer vision system 150, neural network architecture 140, and/or architecture 400.

At step 810, a plurality of images 130 are received at an AGNN architecture 250 that is configured to perform one or more object segmentation functions 170. The segmentation functions 170 may include UVOS functions 171, IOCS functions 172, and/or other functions associated with segmenting images 130. The images 130 received at the AGNN architecture 250 may include images associated with a video 135 (e.g., video frames), or a collection of images (e.g., a collection of images that include semantically similar objects 131 in various semantic classes or a random collection of images).

At step 820, node embeddings 233 are extracted from the images 130 using a feature extraction component 240 associated with the attentive graph neural network architecture 250. The feature extraction component 240 may represent a pre-trained or preexisting neural network architecture (e.g., a FCN architecture), or a portion thereof, that is configured to extract feature information from images 130 for performing segmentation on the images 130. For example, in certain embodiments, the feature extraction component 240 may be implemented using the first five convolution blocks of DeepLabV3. The node embeddings 233 extracted by the feature extraction component 240 comprise feature information that is useful for performing segmentation functions 170.

At step 830, a graph 230 is created that comprises a plurality of nodes 231 that are interconnected by a plurality of edges 232, wherein each node 231 of the graph 230 is associated with one of the node embeddings 233 extracted using the feature extraction component 240. In certain embodiments, the graph 230 may represent a fully-connected graph in which each node is connected to every other node via a separate edge 232.

At step 840, edge embeddings 234 are derived that capture relationship information 265 associated with the node embeddings 233 using one or more attention functions (e.g., associated with attention component 260). For example, the edge embeddings 234 may capture the relationship information 265 for each node pair included in the graph 230. The edge embeddings 234 may include both loop-edge embeddings 235 and line-edge embeddings 236.

At step 850, a message passing function 270 is executed by the AGNN 250 that updates the node embeddings 233 for each of the nodes 231, at least in part, using the relationship information 265. For example, the message passing function 270 may enable each node to update its corresponding node embedding 233, at least in part, using the relationship information 265 associated with the edge embeddings 234 of the edges 232 that are connected to the node 231.

At step 850, segmentation results 160 are generated based, at least in part, on the updated node embeddings 233 associated with the nodes 231. In certain embodiments, after several message passing iterations by the message passing function 270, a final updated node embedding 233 is obtained for each node 231 and a readout function 280 maps the final updated node embeddings to the segmentation results 160. The segmentation results 160 may include the results of performing the UVOS functions 171 and/or IOCS functions 172. For example, the segmentation results 160 may include, inter alia, masks that identify locations of target objects 131. The target objects 131 identified by the masks may include prominent objects of interest (e.g., which may be located in foreground regions) across frames of a video sequence 135 and/or may include semantically similar objects 131 associated with one or more target semantic classes.

In certain embodiments, a system is provided. The system includes one or more computing devices comprising one or more processors and one or more non-transitory storage devices for storing instructions, wherein execution of the instructions by the one or more processors causes the one or more computing devices to: receive, at an attentive graph neural network architecture, a plurality of images; execute, using the attentive graph neural network architecture, one or more segmentation functions on the images, at least in part, by: (i) extracting, using a feature extraction component associated with the attentive graph neural network architecture, node embeddings from the images; (ii) creating a graph that comprises a plurality of nodes that are interconnected by a plurality of edges, wherein each node of the graph is associated with one of the node embeddings extracted using the feature extraction component; (iii) determining, using one or more attention functions associated with the attentive graph neural network architecture, edge embeddings that capture relationship information associated with the node embeddings, wherein each edge of the graph is associated with one of the edge embeddings; and (iv) executing, using the attentive graph neural network architecture, a message passing function that updates the node embeddings for each of the nodes, wherein the message passing function enables each node to update its corresponding node embedding, at least in part, using the relationship information of the edge embeddings corresponding to the edges that are connected to the node; and generate segmentation results based, at least in part, on the updated node embeddings associated with the nodes.

In certain embodiments, a method is provided. The method comprises: receiving, at an attentive graph neural network architecture, a plurality of images; executing, using the attentive graph neural network architecture, one or more segmentation functions on the images, at least in part, by: (i) extracting, using a feature extraction component associated with the attentive graph neural network architecture, node embeddings from the images; (ii) creating a graph that comprises a plurality of nodes that are interconnected by a plurality of edges, wherein each node of the graph is associated with one of the node embeddings extracted using the feature extraction component; (iii) determining, using one or more attention functions associated with the attentive graph neural network architecture, edge embeddings that capture relationship information associated with the node embeddings, wherein each edge of the graph is associated with one of the edge embeddings; and (iv) executing, using the attentive graph neural network architecture, a message passing function that updates the node embeddings for each of the nodes, wherein the message passing function enables each node to update its corresponding node embedding, at least in part, using the relationship information of the edge embeddings corresponding to the edges that are connected to the node; and generating segmentation results based, at least in part, on the updated node embeddings associated with the nodes.

In certain embodiments, a computer program product is provided. The computer program product comprises a non-transitory computer-readable medium including instructions for causing a computer to: receive, at an attentive graph neural network architecture, a plurality of images; execute, using the attentive graph neural network architecture, one or more segmentation functions on the images, at least in part, by: (i) extracting, using a feature extraction component associated with the attentive graph neural network architecture, node embeddings from the images; (ii) creating a graph that comprises a plurality of nodes that are interconnected by a plurality of edges, wherein each node of the graph is associated with one of the node embeddings extracted using the feature extraction component; (iii) determining, using one or more attention functions associated with the attentive graph neural network architecture, edge embeddings that capture relationship information associated with the node embeddings, wherein each edge of the graph is associated with one of the edge embeddings; and (iv) executing, using the attentive graph neural network architecture, a message passing function that updates the node embeddings for each of the nodes, wherein the message passing function enables each node to update its corresponding node embedding, at least in part, using the relationship information of the edge embeddings corresponding to the edges that are connected to the node; and generate segmentation results based, at least in part, on the updated node embeddings associated with the nodes.

While various novel features of the invention have been shown, described, and pointed out as applied to particular embodiments thereof, it should be understood that various omissions, substitutions, and changes in the form and details of the systems and methods described and illustrated, may be made by those skilled in the art without departing from the spirit of the invention. Amongst other things, the steps in the methods may be carried out in different orders in many cases where such may be appropriate. Those skilled in the art will recognize, based on the above disclosure and an understanding of the teachings of the invention, that the particular hardware and devices that are part of the system described herein, and the general functionality provided by and incorporated therein, may vary in different embodiments of the invention. Accordingly, the description of system components are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation. Variations, modifications, and other implementations of what is described herein may occur to those of ordinary skill in the art without departing from the spirit and scope of the present invention and its claims.

What is claimed is:

1. A system comprising:
one or more computing devices comprising one or more processors and one or more non-transitory storage devices for storing instructions, wherein execution of the instructions by the one or more processors causes the one or more computing devices to:
receive, at an attentive graph neural network architecture, a plurality of images;
execute, using the attentive graph neural network architecture, one or more segmentation functions on the images, at least in part, by:
extracting, using a feature extraction component associated with the attentive graph neural network architecture, node embeddings from the images;
creating a graph that comprises a plurality of nodes that are interconnected by a plurality of edges, wherein each node of the graph is associated with one of the node embeddings extracted using the feature extraction component;
determining, using one or more attention functions associated with the attentive graph neural network architecture, edge embeddings that capture relationship information associated with the node embeddings, wherein each edge of the graph is associated with one of the edge embeddings; and
executing, using the attentive graph neural network architecture, a message passing function that updates the node embeddings for each of the nodes, wherein the message passing function enables each node to update its corresponding node embedding, at least in part, using the relationship information of the edge embeddings corresponding to the edges that are connected to the node; and
generate segmentation results based, at least in part, on the updated node embeddings associated with the nodes.

2. The system of claim 1, wherein the one or more segmentation functions executed by the attentive graph neural network architecture include an unsupervised video object segmentation function.

3. The system of claim 2, wherein:
the plurality of images correspond to frames of a video;
the unsupervised video object segmentation function is configured to generate segmentation results that identify or segment one or more objects included in at least a portion of the frames associated with the video.

4. The system of claim 1, wherein the one or more segmentation functions executed by the attentive graph neural network architecture include an image object co-segmentation function.

5. The system of claim 4, wherein
at least one of the images include common objects belonging to a semantic class; and
the object co-segmentation function is configured to jointly identify or segment the common objects included in the semantic class.

6. The system of claim 1, wherein:
the graph is a fully-connected graph;
at least a portion of the edges are associated with line-edge embeddings that are obtained using an inter-node attention function; and
the line-edge embeddings capture pair-wise relationship information for node pairs included in the fully-connected graph.

7. The system of claim 6, wherein:
at least a portion of the edges of the graph are associated with loop-edge embeddings that are obtained using an intra-node attention function; and
the loop-edge embeddings capture internal relationship information within the nodes of the fully-connected graph.

8. The system of claim 7, wherein the message passing function updates the node embeddings for each of the nodes, at least in part, using the pair-wise relationship associated with the line-edge embeddings and the internal relationship information associated with the loop-edge embeddings.

9. The system of claim 1, wherein the message passing function is configured to filter out information from noisy or irrelevant images included in the plurality of images.

10. The system of claim 1, wherein the attentive graph neural network architecture is stored on an image capturing device or is configured to perform post-processing operations on images that are generated by an image capturing device.

11. A method comprising:
receiving, at an attentive graph neural network architecture, a plurality of images;
executing, using the attentive graph neural network architecture, one or more segmentation functions on the images, at least in part, by:
extracting, using a feature extraction component associated with the attentive graph neural network architecture, node embeddings from the images;
creating a graph that comprises a plurality of nodes that are interconnected by a plurality of edges, wherein each node of the graph is associated with one of the node embeddings extracted using the feature extraction component;
determining, using one or more attention functions associated with the attentive graph neural network architecture, edge embeddings that capture relationship information associated with the node embeddings, wherein each edge of the graph is associated with one of the edge embeddings; and
executing, using the attentive graph neural network architecture, a message passing function that updates the node embeddings for each of the nodes, wherein the message passing function enables each node to update its corresponding node embedding, at least in part, using the relationship information of the edge embeddings corresponding to the edges that are connected to the node; and
generating segmentation results based, at least in part, on the updated node embeddings associated with the nodes.

12. The method of claim 11, wherein the one or more segmentation functions executed by the attentive graph neural network architecture include an unsupervised video object segmentation function.

13. The method of claim 12, wherein:
the plurality of images correspond to frames of a video;
the unsupervised video object segmentation function is configured to generate segmentation results that identify or segment one or more objects included in at least a portion of the frames associated with the video.

14. The method of claim 11, wherein the one or more segmentation functions executed by the attentive graph neural network architecture include an image object co-segmentation function.

15. The method of claim 14, wherein
at least one of the images include common objects belonging to a semantic class; and
the object co-segmentation function is configured to jointly identify or segment the common objects included in the semantic class.

16. The method of claim 11, wherein:
the graph is a fully-connected graph;
at least a portion of the edges are associated with line-edge embeddings that are obtained using an inter-node attention function; and
the line-edge embeddings capture pair-wise relationship information for node pairs included in the fully-connected graph.

17. The method of claim 16, wherein:
at least a portion of the edges of the graph are associated with loop-edge embeddings that are obtained using an intra-node attention function; and
the loop-edge embeddings capture internal relationship information within the nodes of the fully-connected graph.

18. The method of claim 17, wherein the message passing function updates the node embeddings for each of the nodes, at least in part, using the pair-wise relationship associated with the line-edge embeddings and the internal relationship information associated with the loop-edge embeddings.

19. The method of claim 11, wherein the message passing function is configured to filter out information from noisy or irrelevant images included in the plurality of images.

20. A computer program product comprising a non-transitory computer-readable medium including instructions for causing a computer to:
receive, at an attentive graph neural network architecture, a plurality of images;
execute, using the attentive graph neural network architecture, one or more segmentation functions on the images, at least in part, by:
extracting, using a feature extraction component associated with the attentive graph neural network architecture, node embeddings from the images;
creating a graph that comprises a plurality of nodes that are interconnected by a plurality of edges, wherein each node of the graph is associated with one of the node embeddings extracted using the feature extraction component;
determining, using one or more attention functions associated with the attentive graph neural network architecture, edge embeddings that capture relationship information associated with the node embeddings, wherein each edge of the graph is associated with one of the edge embeddings; and
executing, using the attentive graph neural network architecture, a message passing function that updates the node embeddings for each of the nodes, wherein the message passing function enables each node to update its corresponding node embedding, at least in part, using the relationship information of the edge embeddings corresponding to the edges that are connected to the node; and
generate segmentation results based, at least in part, on the updated node embeddings associated with the nodes.
